(19) United States
(12) Patent Application Publication
(10) Pub. No.: US 2010/0145831 A1
(43) Pub. Date: Jun. 10, 2010

(54) AUTOMATED DATA MANAGEMENT SYSTEM

(75) Inventors: Paige Esfandiari, Woodland Hills, CA (US); Tony Esfandiari, Woodland Hills, CA (US); Peter Messbauer, West Hills, CA (US)

Correspondence Address: THE ECLIPSE GROUP LLP, 10605 BALBOA BLVD., SUITE 300, GRANADA HILLS, CA, 91344, US

(73) Assignee: Global Marketing Partners, Inc., Woodland Hills, CA (US)

(21) Appl. No.: 12/548,341

(22) Filed: Aug. 26, 2009

Related U.S. Application Data
(60) Provisional application No. 61/092,002, filed on Aug. 26, 2008.

(51) Int. Cl. G06Q 10/00; G06F 17/30

(52) U.S. Cl. 705/28; 705/30; 707/802; 707/705; 707/E17.044; 707/E17.001

(57) ABSTRACT

An automated data management system that includes a database that receives and stores data related to multiple products and services sold by resellers and distributors. The database contains current and historic sales data that is cross-referenced by product identifier, reseller, and distributor. The data management system also includes a user interface that permits a user to access the data management system and generate reports that summarize and display the sales data in selected formats. A method of implementing and operating such a data management system is also disclosed.

### RELATED APPLICATION(S)

This application claims priority of U.S. Provisional Patent Application Ser. No. 61/092,002, filed on Aug. 26, 2008, titled “AUTOMATED DATA MANAGEMENT SYSTEM,” which application is incorporated in its entirety in this application by this reference.

### BACKGROUND OF THE INVENTION

1. Field of the Invention

This invention relates, in general, to automated data management systems and, in particular, to a system that consolidates sales data related to products or services.

2. Related Art

Business entities that manufacture, sell, distribute, and/or purchase products or services need to track sales history by retailer, distributor, product, product category, and purchaser category, as well as track inventory, product fulfillment, and other related data to accurately manage their business. Typically, data related to this information is provided to the various manufacturers and distributors on a daily or weekly basis in the form of raw data that is then required to be imported, encoded, extrapolated, manipulated, compared, and interpreted for a company to gain the necessary knowledge to make business decisions on products, product sales, product placement, order fulfillment, etc.

In general, a product is typically manufactured by, or on behalf of, a vendor. The vendor may then sell its products to various resellers (i.e., retail chains, value-added resellers, government and corporate resellers, Internet resellers, etc.). Some vendors may not sell directly to resellers, but may sell through distribution channels, in which case their products are distributed to the retail outlets by distributors that may deliver aggregated shipments of various vendors' products to the retailers. The distributors maintain products in inventory from various vendors for reseller order fulfillment. In some cases, when a product is not sold in high volumes or when a vendor is not approved to sell to a specific distributor or a vendor has not approved any distributors, a product aggregator, who is approved to sell to a distributor, will be used by a vendor to sell products through the distributor. Several distributors are often utilized by a single vendor.

A need therefore exists for an automated management tool that collects, encodes, and consolidates current and historic raw data related to numerous products that may be sold by numerous resellers and/or distributors and provides a user with a centralized data management tool that allows for the automated viewing, manipulating, analyzing, and exporting of such data. A need further exists for an automated management tool that allows for report generation based upon useful user-selected parameters, such as product, product category, purchaser, purchaser category, distributors, resellers, time frame, etc. The present invention fulfills such a need.

### SUMMARY

According to one implementation, an automated data management system that includes a database and a user interface is disclosed. Current and historic sales data are stored on the database, where the sales data is categorized and cross-referenced by product, reseller, and distributor. Each product may be identified by a unique identifier, such as stock-keeping unit (“SKU”). Through the user interface, a user may select any combination of sales data that is selected by product, reseller, or distributor, or by category of product or reseller. The selected sales data may then be processed, summarized, and compared with historical data for the same combination over any time period. The selected sales data may also be displayed to the user in various formats, such as charts, graphs, and other visual aids.

A method of implementing and operating an automated data management system is also disclosed. The data management system may receive electronic sales data daily, weekly, or monthly, and continuously update a database with current sales while maintaining historic data. Thus, a user may continuously access the data management system to receive both current and historic sales data.

Other devices, apparatus, systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates one example of a user interface of a data management system of the invention showing a sales report consisting of current and historic sales data by reseller for all distributors for all products.

FIG. 2 illustrates one example of a user interface of a data management system of the invention showing a sales report consisting of current and historic sales data by reseller for all distributors for select product stock-keeping units (“SKUs”).

FIG. 3 illustrates one example of a user interface of a data management system of the invention showing a sales report consisting of current and historic sales data by reseller for select distributors for all products.

FIG. 4 illustrates one example of a user interface of a data management system of the invention showing a sales report consisting of current and historic sales data by reseller for select distributors for select product SKUs.

FIG. 5 illustrates one example of a user interface of a data management system of the invention showing a sales report consisting of current and historic sales data by reseller category for all distributors for all products.

FIG. 6 illustrates one example of a user interface of a data management system of the invention with one reseller's sale data highlighted and illustrating the line graph on the left-hand side of the chart showing the sales trend for the highlighted reseller.

FIG. 7 illustrates one example of a user interface of a data management system of the invention with another reseller's sale data highlighted and illustrating the line graph on the left-hand side of the chart showing the sales trend for the highlighted reseller.

FIG. 8 illustrates one example of a user interface of a data management system of the invention that provides a user with the ability to set preferences and to categorize product SKUs and resellers.

FIG. 9 illustrates a flow diagram of an example implementation of a process of implementing, maintaining, and operating a data management system in accordance with the invention.

### DETAILED DESCRIPTION

In the following detailed description of the examples of various implementations, it will be understood that any direct connection or coupling between functional blocks, devices, components or other physical or functional units shown in the drawings or description in this application could also be implemented by an indirect connection or coupling. It will also be understood that the features of the various implementations described in this application may be combined with each other, unless specifically noted otherwise.

An automated data management system may be configured to receive and store sales data received from various resellers and distributors related to the numerous products sold by each of them. In the examples of user interfaces described in more detail below, each product may be identified by a stock-keeping unit (“SKU”), which is a unique identifier that is assigned to each product or service sold by a reseller or distributor. SKUs may also be assigned to each variant of a product, i.e., one SKU to red widgets and another to blue widgets. If the widgets are packed 10 to a box, the box of widgets is the SKU. Other product tracking methods may be also be used, such as Universal Product Code (“UPC”), European Article Number (“EAN”), and Global Trade Item Number (“GTIN”).

SKUs can also be assigned to services as well as actual physical items. For example, extended warranties applicable to a physical product may be assigned their own SKUs, and the same applies to, for example, delivery fees, installation fees, and service contracts.

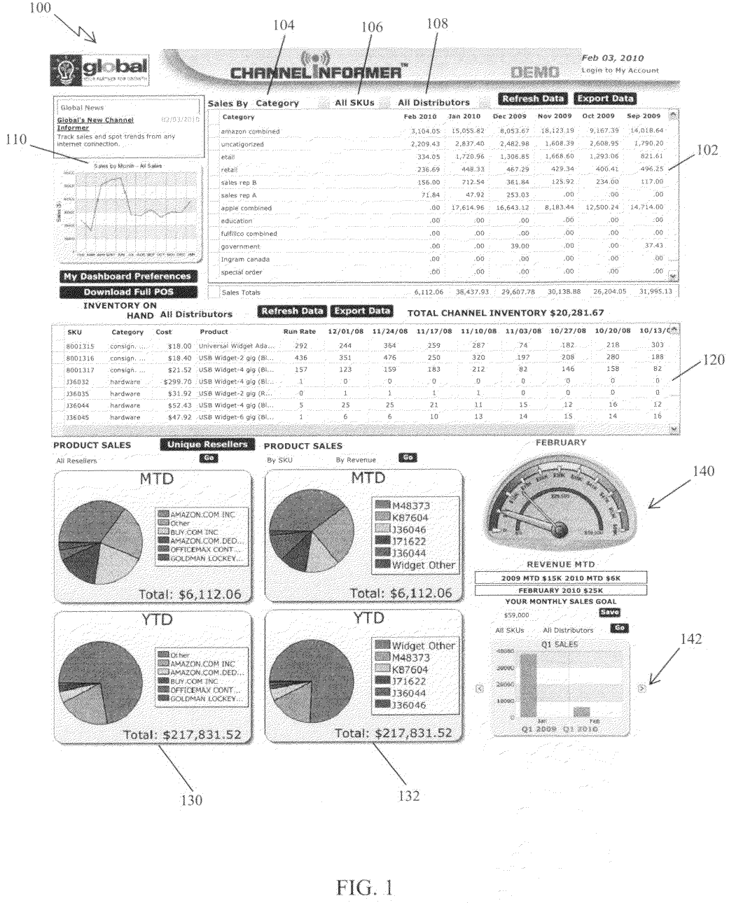

As illustrated in FIGS. 1-7, in one implementation of the invention, the invention is described in the context of an automated data management system containing augmented vendor-specific data. While the invention is illustrated based upon vendor-specific data related to the sales and inventory of product flowing through distribution and resell channels, those skilled in the art will recognize that the data management system of the invention may be utilized in connection with any business or industry in which the aggregation of data from various sources and the sorting of such data based upon multiple user-defined parameters are required to track business performance.

In general, the automated data management system of the invention aggregates raw and electronic data received from various distributors and/or resellers continuously at various time intervals. Some distributors and/or resellers may provide daily reports, whereas others may provide weekly or monthly reports. In the illustrated examples, the data are aggregated in a vendor-specific manner. The vendor-specific information may then be processed and stored in a database such that the vendor-specific information may be viewed, for example, over the Internet, and retrieved by a vendor based upon selected parameters, utilizing a user interface. The user interface may be a graphical user interface (“GUI”) that includes graphical icons and visual indicators.

For example, as illustrated by the sales charts in the top right hand corner of the following FIGS. 1-5, the following information may be tracked by selecting different combinations of options from drop down menus. Turning to FIG. 1, a user interface of a data management system of the invention showing a sales report 100 consisting of current and historic sales data for all resellers and all distributors of all products, where the products are identified by stock-keeping units (“SKUs”), is depicted. The sales chart 102 in the upper-right hand corner of the sales report 100 shows sales by all resellers over a six-month period (March 2008 through August 2008) for all SKUs and for all distributors, where the parameters Reseller, All SKUs, and All Distributors may be selected as options from the drop-down menus 104, 106, and 108, respectively. Although not illustrated in FIG. 1, the data may also be presented in any other time increment over a selected time period, and the data management system may also be designed to allow the user to select these time parameters. As used in this application, the term “all reseller” shall mean all resellers for which data is recorded and stored in the data management system. Similarly, “all distributors” shall mean all distributors for which data is recorded and stored in the data management system and “all products” shall mean all products for which data is recorded and stored in the data management system.

Also included in sales report 100 is a graphical sales chart 110 that shows sales information in graphical table format to illustrate sales trends over a given time period, in this case, All Sales for the period of August 2007 through July 2008. Also, as illustrated by inventory-on-hand chart 120 of FIG. 1, the vendor may be provided with data that allows the vendor to track inventory on hand for various products by all distributors or by select distributors. The inventory data may provide the vendor with historic data regarding inventory carried by all or specific distributors and further include a run time (or turn rate) calculation for each product that represents the average sales by product over a specific time period. All the columns in the inventory table may be sorted by SKU, product category, cost and/or product description. As shown in inventory-on-hand chart 120, various products identified by SKU are listed, together with a unit cost, product description, run rate (or turn rate), and a month-by-month count of the number of that product held by all distributors.

As illustrated by the pie charts 130 and 132 in the bottom left hand corner of FIG. 1, further graphical data representations may also be displayed to provide vendors with quick year-to-date and month-to-date reference data based upon any combination of the following parameters: Unique Resellers; All Resellers; Product SKU; Product Category; Revenue; and Quantity. In sales report 100, pie chart 130 shows month-to-date and year-to-date product sales by all resellers in the form of a pie chart where the share of each reseller is shown as a “slice” of the pie (with “Other” resellers having their own share). Likewise, pie chart 132 shows month-to-date and year-to-date product sales by product SKU in the form of a pie chart where the share of each product is shown as a “slice” of the pie (again, with “Other” products having its own share).

Sales goals (in terms of revenue) may also be tracked over predetermined time frames and illustrated in graphical form. As an example, a so-called “meter graph” 140 shows the current year's and last year's month-to-date (“MTD”) sales, the monthly sales goal, and the progress toward that goal. Sales data for prior years based upon product and distributor data may also be compared for a given period of time, e.g., monthly, quarterly, or yearly. As an example, bar graph 142 shows a comparison of the sales of all SKUs from all distributors for the 3^{rd} quarter of 2007 with the 3^{rd} quarter of 2008.

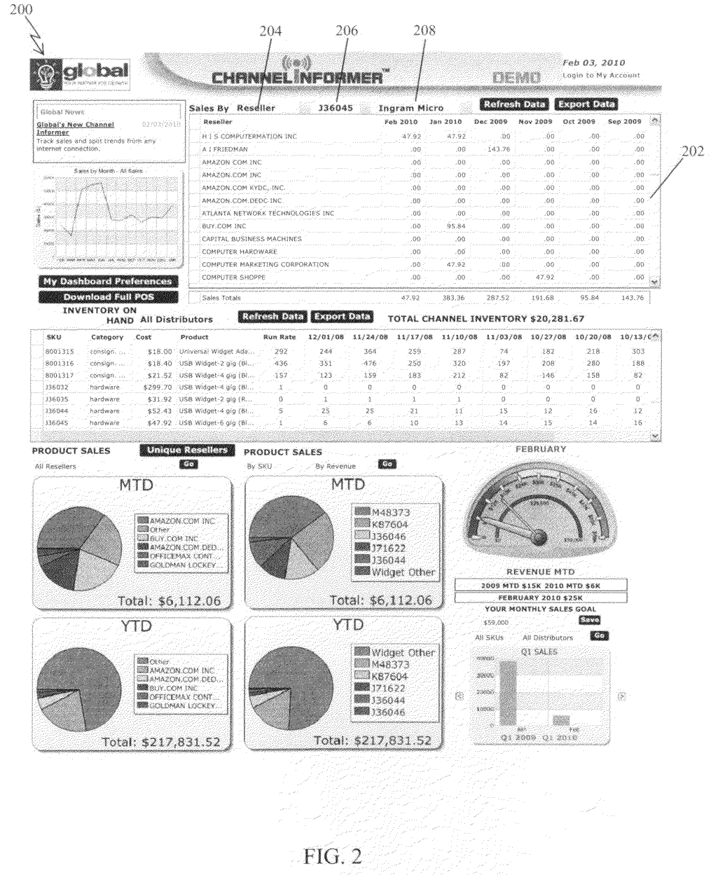

In FIG. 2, a user interface of a data management system of the invention showing a sales report 200 consisting of current and historic sales data for all resellers and all distributors of selected product(s) SKUs is depicted. The sales chart 202 in the upper-right hand corner of the sales report 200 shows sales by all resellers and for all distributors over a six-month period (March 2008 through August 2008) of the product identified by SKU 8001315, where the parameters Reseller, SKU 8001315, and All Distributors may be selected as options from the drop-down menus 204, 206, and 208, respectively. Although not illustrated in FIG. 2, the data may also be presented in any other time increment over a selected time period, and the data management system may also be designed to allow the user to select these time parameters.

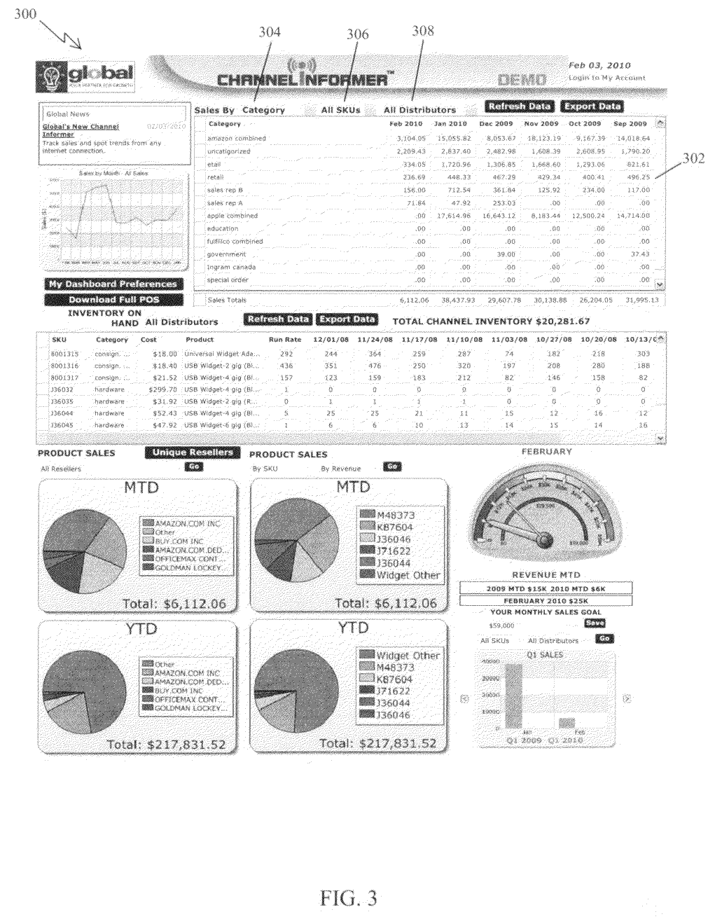

In FIG. 3, a user interface of a data management system of the invention showing a sales report 300 consisting of current and historic sales data for all resellers from selected distributors of all products is depicted. The sales chart 302 in the upper-right hand corner of the sales report 300 shows sales by all resellers from a single distributor, in this example, Ingram Micro, over a six-month period (March 2008 through August 2008) for all SKUs, where the parameters Reseller, All SKUs, and Distributor Ingram Micro may be selected as options from the drop-down menus 304, 306, and 308, respectively. Although not illustrated in FIG. 3, the data may also be presented in any other time increment over a selected time period, and the data management system may also be designed to allow the user to select these time parameters.

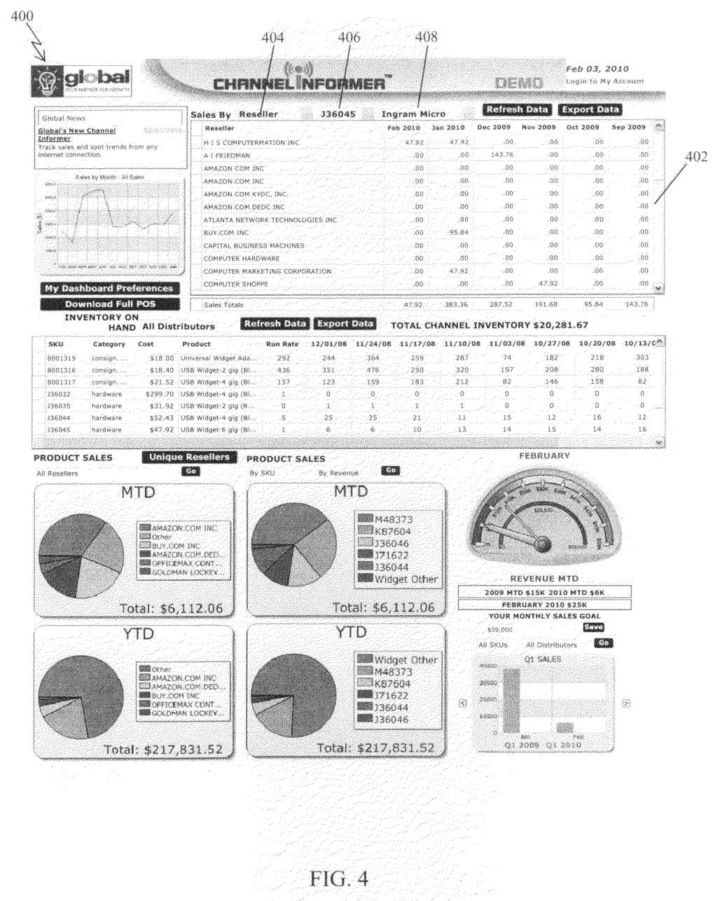

In FIG. 4, a user interface of a data management system of the invention showing a sales report 400 consisting of current and historic sales data for all resellers from selected distributor(s) of selected product(s) is depicted. The sales chart 402 in the upper-right hand corner of the sales report 400 shows sales by all resellers from distributor Ingram Micro over a six-month period (March 2008 through August 2008) of the product identified by SKU 336045, where the parameters Reseller, SKU 336045, and Distributor Ingram Micro may be selected as options from the drop-down menus 404, 406, and 408, respectively. Although not illustrated in FIG. 4, the data may also be presented in any other time increment over a selected time period, and the data management system may also be designed to allow the user to select these time parameters.

Additionally, resellers may be categorized and consolidated to provide more accurate reporting. Often times, raw data from various distributors will have slightly different names for the same vendor. The data management system can be designed to allow users to not only consolidate reseller information under one company name, but also to categorize resellers by, for example, industry segments, to track product performance by industry or other suitable categorization. In this manner, users may establish their own categories by which to sort the resellers as necessary to tailor reporting to their business needs. Similarly, products may also be categorized and consolidated by product category or type as necessary to tailor reporting for a particular vendor.

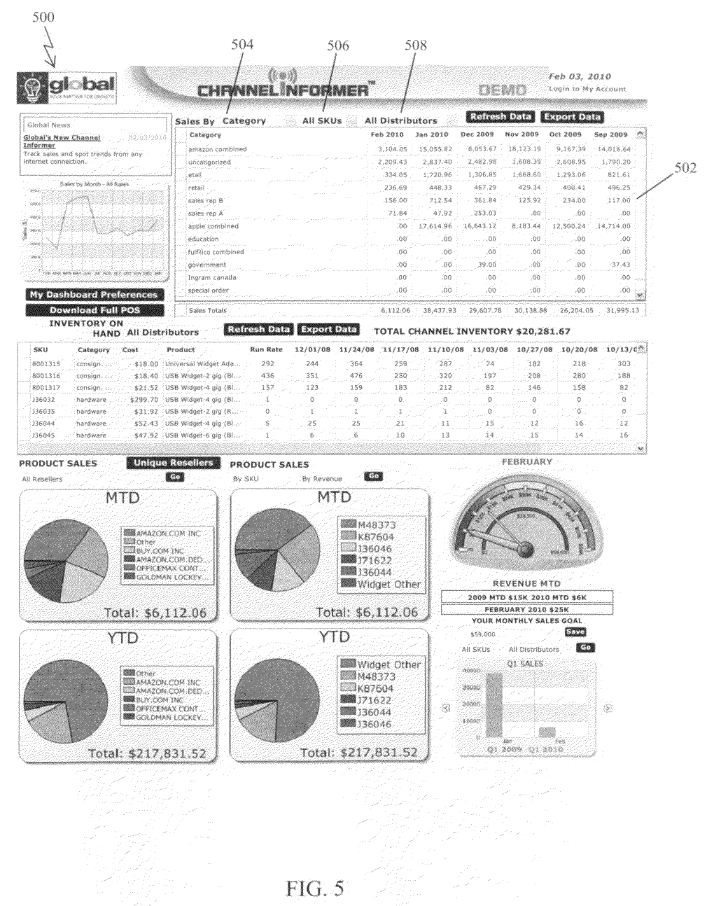

As an example, in FIG. 5, a user interface of a data management system of the invention showing a sales report 500 consisting of current and historic sales data for a category of resellers and all distributors of all products, where the products are identified by SKUs, is depicted. The sales chart 502 in the upper-right hand corner of the sales report 500 shows sales by a category of resellers over a six-month period (March 2008 through August 2008) for all SKUs and for all distributors, where the parameters Category of Reseller, All SKUs, and All Distributors may be selected as options from the drop-down menus 504, 506, and 508, respectively. Although not illustrated in FIG. 5, the data may also be presented in any other time increment over a selected time period, and the data management system may also be designed to allow the user to select these time parameters.

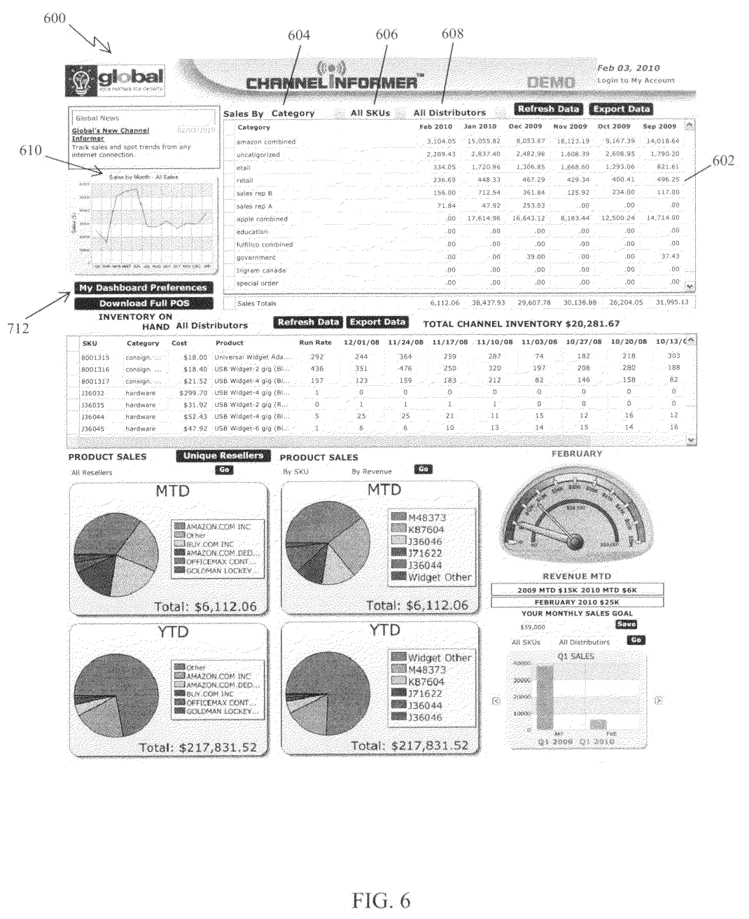

Turning to FIG. 6, a user interface of a data management system of the invention showing a sales report 600 consisting of current and historic sales data for all resellers and all distributors of all products is depicted. The sales chart 602 in the upper-right hand corner of the sales report 600 shows sales by all resellers over a six-month period (March 2008 through August 2008) for all SKUs and for all distributors, where the parameters Reseller, All SKUs, and All Distributors may be selected as options from the drop-down menus 604, 606, and 608, respectively. In these respects, FIG. 6 is similar to FIG. 1 described above. However, FIG. 6 also illustrates how the data management system may also provide sales information in graphical table format to illustrate sales trends over a given time period. By selecting the reseller “AMAZON.COM.DEDC INC” (on line 3 of the listing, as noted by the >), a graphical sales chart 610 appears that shows sales information in graphical table format to illustrate sales trends over a given time period, in this case, All Sales for the period of August 2007 through July 2008, for the selected reseller, Amazon.com.

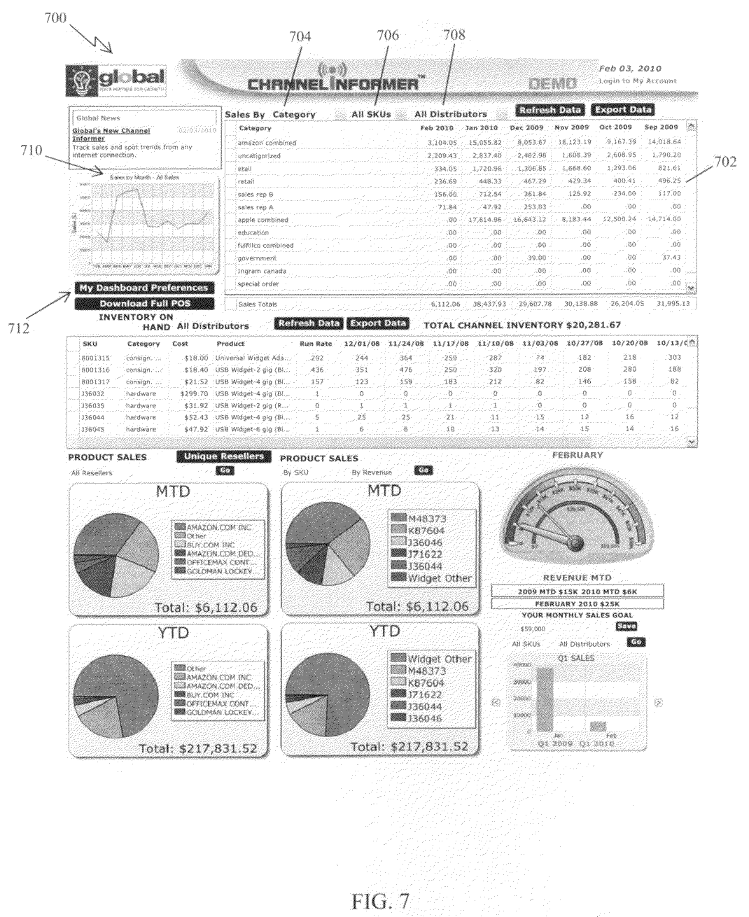

Similarly, FIG. 7 depicts a user interface of a data management system of the invention showing a sales report 700 consisting of current and historic sales data for all resellers and all distributors of all products is depicted. FIG. 7 is similar to FIG. 6 described above, with the exception that the reseller “OVERSTOCK.COM INC” is selected (on line 10 of the listing, as noted by the >), and the graphical sales chart 710 shows sales information in graphical table format to illustrate sales trends over a given time period, in this case, All Sales for the period of August 2007 through July 2008, for the selected reseller, Overstock.com.

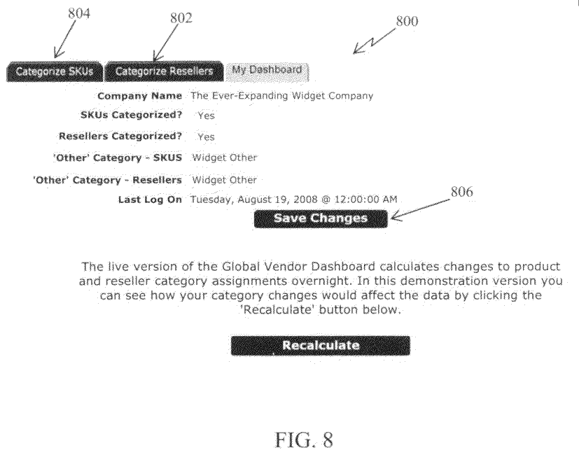

In the illustrated examples of FIGS. 6 and 7, such categories of reseller may be established by setting user preferences, which may, for example, be accessed via an icon on the user interface. Examples of such icons are the “My Dashboard Preferences” buttons 612 and 712 of FIGS. 6 and 7, respectively. Once selected, the user will be directed to a different user interface at which the user can establish reseller and product categories. An example of such an interface is illustrated by FIG. 8. At the user interface 800 shown in FIG. 8, a user may categorize resellers and product SKUs by clicking tabs 802 and 804, respectively, which, for example, may provide the user with drop down menus, which the user may utilize to establish the desired reseller and product categories. Once the user has finished, the categorizations may be saved by clicking on tab 806.

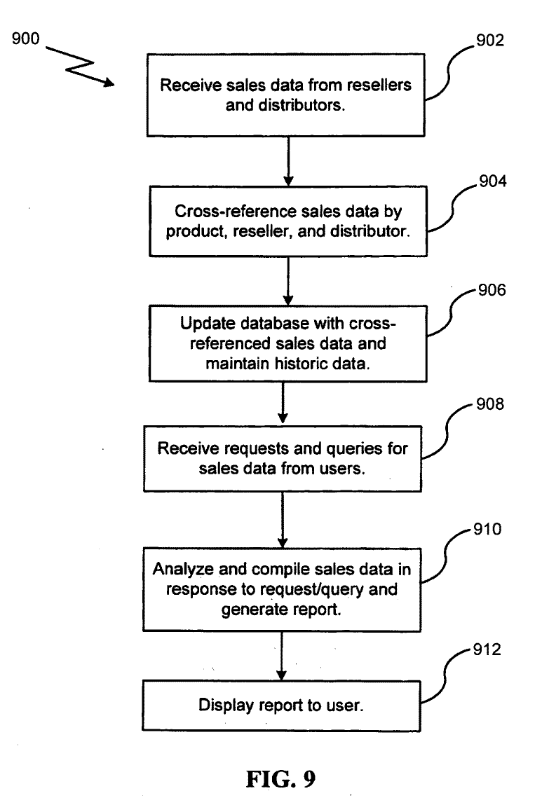

Turning to FIG. 9, a flow diagram 900 of an example implementation of a process of implementing, maintaining, and operating a data management system in accordance with the invention is depicted. In step 902, the data management system continuously receives electronic sales data from various distributors and/or resellers at various time intervals, e.g., daily, monthly, or weekly. In step 904, the sales data is processed and cross-referenced by various parameters, such as product identifier, reseller, and distributor, as well as by date. Essentially, in this step, the sales data is processed and encoded so that all sales data may be aggregated and later categorized and summarized in response to queries from users of the data management system.

In step 906, the database is periodically updated with the cross-referenced sales data, while at the same time, the data management system may also be maintaining historic sales data. Because the data management system requires historical sales data for many of the charts and graphs, such historical sales data may be obtained from other sources and input into the system during the initial start-up period.

In step 908, the data management system receives requests for reports and queries for users of the system through a user interface, which may be a graphical user interface (“GUI”). As shown in FIGS. 1-8, the user may have several options available as to the content and format of the requested sales information. In step 910, the data management system retrieves the appropriate sales data from the database, consolidates and manipulates current and historic data, and then formats the results for the selected reporting format. In step 912, the report generated by the data management system is displayed to the user through the GUI. Steps 908, 910, and 912 may then be repeated, as, for example, shown in FIGS. 6 and 7, where the user may select an entry in a sales report for additional or reformatted information.

All of the reports and information viewed by a user utilizing the system may be exported and downloaded. Exporting the generated data and reports may be helpful to a business in a number of ways, for example, to track product performance by various parameters, track inventory, and calculate commissions, royalties, and other product-related data.

Those skilled in the art will recognize that the illustration and reporting of all the system data may be conveyed to the user in a variety of ways. The invention should not be limited by the manner in which the graphical user interface shown in FIGS. 1-8 reports the information to the user.

The system data may be accessed remotely, by vendors, through a graphical user interface, such as the one shown in FIGS. 1-8, through a secure Internet connection. For example, the database management system may be considered “Software as a Service” or a “SaaS”, and accordingly, offered by a provider to customers as an Internet accessible service on demand. Alternatively, software may be licensed to vendors or customers for installation locally, and may therefore be resident on a vendor's computer. The remote software application will then provide direct communication with a remote server via the Internet or other means of communicating with the server to access the vendor-specific data. When the software resides on the vendor's end, the data may reside on a remote server or may be copied to a local server when requested or at predetermined times.

It will be understood, and is appreciated by persons skilled in the art, that one or more processes, sub-processes, or process steps described in connection with the data management system may be performed by hardware and/or software. If the process is performed by software, the software may reside in software memory (not shown) in a suitable electronic processing component or system such as one or more of the functional components or modules. The software in software memory may include an ordered listing of executable instructions for implementing logical functions (that is, “logic” that may be implemented either in digital form such as digital circuitry or source code or in analog form such as analog circuitry or an analog source such as an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device, and execute the instructions. In the context of this disclosure, a “computer-readable medium” is any means that may contain, store, or communicate the program for use by or in connection with the instruction execution system, apparatus, or device. The computer-readable medium may selectively be, for example, but is not limited to, an electronic, magnetic, optical, electromagnetic, infrared, or semiconductor system, apparatus, or device. More specific examples, but nonetheless a non-exhaustive list, of computer-readable media would include the following: a portable computer diskette (magnetic), a random access memory (“RAM”) (electronic), a read-only memory (“ROM”) (electronic), an erasable programmable read-only memory (“EPROM” or Flash memory) (electronic), and a portable compact disc read-only memory (“CDROM”) (optical). Note that the computer-readable medium may even be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

The foregoing description of an implementation has been presented for purposes of illustration and description. It is not exhaustive and does not limit the claimed invention to the precise form disclosed. Modifications and variations are possible in light of the above description or may be acquired from practicing the invention. The claims and their equivalents define the scope of the invention.

What is claimed is:

1. A data management system comprising:
a database containing vendor-specific time-relative sales data categorized and cross-referenced by parameters of product, distributor, and reseller; and
a user interface that permits a user to generate reports based upon the time-relative sales data based upon predetermined time intervals, over a predetermined time period, further based upon any combination of the parameters.

2. The data management system of claim 1, where each product is identified by a stock-keeping unit (“SKU”) identifier.

3. The data management system of claim 1, where the database further includes sales information categorized and cross-referenced by product category.

4. The data management system of claim 1, where the database further includes sales information categorized and cross-referenced by reseller category.

5. The data management system of claim 1, where the database further includes distributor-specific inventory information based upon product SKU.

6. The data management system of claim 1, where the database contains run-time information for each product.

7. The data management system of claim 1, where the generated reports may be exported from the system.

8. The data management system of claim 1, where the data management system is available to users as an Internet accessible service.

9. The data management system of claim 1, where the user interface is a graphical user interface (“GUI”).

10. A method of implementing an automated data management system for sales data, the method comprising:
receiving sales data from resellers and distributors, where the sales data relates to products sold or purchased by the resellers and distributors;
cross-referencing the sales data by product identifier, reseller, and distributor; and
storing the cross-referenced sales data in a database of the data management system.

11. The method of claim 10, further including the step of maintaining historic sales data related to the products, resellers, and distributors.

12. The method of claim 11, where each product is identified by a stock-keeping unit (“SKU”) identifier.

13. The method of claim 11, further including the steps of:
receiving requests from users for sales data from the database;
retrieving sales data from the database responsive to a request from a user;
analyzing the retrieved sales data;
formatting the analyzed sales data in a sales report; and
displaying the sales report to the user.

14. The method of claim 13, where the request from the user includes selected products, resellers, or distributors.

15. The method of claim 14, where the request from the user includes a selected category of products or resellers.

16. The method of claim 13, where the request from the user includes a selected time period for the retrieved sales data.

17. The method of claim 13, where the retrieved sales data includes historic sales data, where the historic sales data is used in a sales report for comparison purposes.

18. A computer-readable media with instructions that when executed by an instruction execution system performs a method of implementing an automated data management system for sales data, the method comprising:
receiving sales data from resellers and distributors, where the sales data relates to products sold or purchased by the resellers and distributors;
cross-referencing the sales data by product identifier, reseller, and distributor;
storing the cross-referenced sales data in a database of the data management system; and
maintaining historic sales data related to the products, resellers, and distributors.

19. The computer-readable media of claim 18, further including the steps of:
receiving requests from users for sales data from the database;
retrieving sales data from the database responsive to a request from a user;
analyzing the retrieved sales data;
formatting the analyzed sales data in a sales report; and
displaying the sales report to the user.

20. The computer-readable media of claim 19, where the request from the user includes selected products, resellers, or distributors.
